(19) United States
(12) Patent Application Publication
(10) Pub. No.: US 2026/0036358 A1
(43) Pub. Date: Feb. 5, 2026

(54) TOE-KICK PLATE ATTACHMENT SYSTEM FOR APPLIANCE

(71) Applicant: FISHER & PAYKEL APPLIANCES LIMITED, Auckland (NZ)

(72) Inventor: James Mawer, Auckland (NZ)

(21) Appl. No.: 19/099,115

(22) PCT Filed: Jul. 31, 2023
(86) PCT No.: PCT/NZ2023/050074

§ 371 Date: Jan. 28, 2025

(30) Foreign Application Priority Data
Jul. 29, 2022 (NZ) 790809

(51) Int. Cl. F25D 23/10; F16B 12/20

(52) U.S. Cl. CPC F25D 23/10; F16B 12/20

(57) ABSTRACT

A locking system for a toe-kick plate of an appliance includes a toe-kick plate having a substantially planar body with a first, inward-facing, surface and a second, outward-facing, surface, the toe-kick plate having a bracket leg extending from the second surface. The appliance has a cabinet body with a shaped channel configured to receive at least a portion of the bracket leg, the shaped channel including at least first and second channel walls. A wedging member is locatable between the walls of the shaped channel, such that the bracket leg is frictionally locked within the shaped channel between at least one of the channel walls and the wedging member. The wedging member is adjustably advanceable within the shaped channel such that a frictional locking force applied to the bracket leg can be varied.

### TECHNICAL FIELD

The present disclosure generally relates to a method of locking the position of a slidably engaged bracket leg. Particularly, but not exclusively, it relates to a toe-kick attachment mechanism for use with an appliance or kitchen appliance, such as a refrigeration appliance cabinet.

### BACKGROUND

It is known that commercial and domestic (i.e., “home”) appliances are often installed into alcoves or spaces defined by a surrounding structure and/or other appliances and cabinetry in such a way that they are practically indistinguishable from the surrounding cabinetry. These “integrated” (or “built in”) appliances can be installed in several stages, with a main frame or body being installed first followed by external, outwardly-facing panelling added to the front of the door and often a toe-kick (otherwise known as kick-strip) plate adjacent the floor, recessed behind the front face of the panelling. It is desirable that these toe-kick plates be adjustable such that they can be used across a range of appliances as well as account for any depth offsets or misalignments between the appliance and the surrounding installation space/cabinetry.

In a conventional installation, it is difficult to make such adjustments to the toe-kick plate once the appliance cabinet has been installed and access from the side or rear is no-longer practical.

It is an object of the present invention to mitigate this issue.

### SUMMARY

In accordance with an aspect of the invention, there is provided a locking system for a toe-kick plate of an appliance, the locking system comprising: a toe-kick plate having a substantially planar body with a first inward facing surface and a second outward facing surface, the toe-kick plate further comprising a bracket leg extending from the second surface; a cabinet body having a shaped channel configured to receive at least a portion of the bracket leg, the shaped channel comprising at least first and second channel walls; and a wedging member locatable between the walls of the shaped channel, such that the bracket leg is frictionally locked within the shaped channel between at least one of the channel walls and the wedging member, wherein the wedging member is adjustably advanceable within the shaped channel such that a frictional locking force applied to the bracket leg can be varied.

This arrangement enables a user to adjust the extent to which the bracket leg is inserted within the shaped channel (and thereby adjust the depth of the toe-kick plate) as desired. Subsequent insertion of the wedging member frictionally locks the bracket leg within the shaped channel as the wedging member is drawn into the shaped channel, forcing the bracket leg against the channel walls and providing a clamping force. Advantageously, the position of the wedging member along the shaped channel can be adjusted so as to vary this clamping force, allowing for the bracket leg to be repositioned.

Optionally, the wedging member comprises a trailing wedge-shaped portion having a first angle at a first position along its length.

Optionally, the shaped channel has a first engaging surface that is positioned to be engaged by the trailing wedge-shaped portion as the wedging member is advanced within the shaped channel such that the first engaging surface urges the wedging member against the first and/or second channel wall(s).

Optionally, the wedging member further comprises a leading wedge-shaped portion having a second angle at a second position along its length.

Optionally, the shaped channel has a second engaging surface that is positioned to be engaged by the leading wedge-shaped portion as the wedging member is advanced within the shaped channel such that the second engaging surface urges the wedging member against the first and/or second channel wall(s).

Optionally, the first and second angles are the same.

The use of multiple distinct wedging portions rather than a single wedged interface between the wedging member and the walls of the shaped channel servers to prevent the wedging member locking up or otherwise becoming stuck, as may be the case for a single larger mating surface.

Optionally, the first and second channel walls are angled towards each other along a first portion of the shaped channel, such that the first portion of the shaped channel has a non-uniform width along its length.

Optionally, in a second portion of the shaped channel, the first and second channel walls are angled away from each other.

Accordingly, by varying the location of the wedging member along the shaped channel, the clamping force applied to the bracket leg.

Optionally, the shaped channel comprises a wedged portion having a third angle configured to engage a wedge-shaped portion of the wedging member.

Optionally, the angle of the wedged portion is different to that of the wedging member.

Providing a mating surface having a different angle to that of the wedge-shaped portion of the wedging member minimizes the contact area between the wedging portion and the shaped channel which serves to prevent sticking or frictional locking between to the two components.

Optionally, the locking mechanism further comprises a threaded rod arranged to extend at least partially along the length of the shaped channel and through the wedging member, the threaded rod restrained from moving axially relative to the cabinet body such that rotating the threaded rod adjusts position of the wedging member along the shaped channel.

This allows for the wedging member to be continuously advanced within or retracted from the shaped channel by interacting with the screw head located at the front of the assembly, rather than requiring access to both ends of the shaped channel.

Optionally, the threaded rod further comprises a nut or abutment at or near its end to limit the extent of travel of the wedging member along the threaded rod.

This prevents the wedging member from falling entirely out of the shaped channel.

Optionally, the threaded rod is attached at one end to the bracket leg.

Optionally, the threaded rod engages with a threaded through hole in the bracket leg.

Optionally, the wedging member comprises first and second sub-wedging members, and wherein each of the first and second sub-wedging member are independently advanceable along the shaped channel.

Optionally, the first sub-wedging member is locatable in a first portion of the shaped channel and the second sub-wedging member is locatable in a second portion of the shaped channel.

Optionally, the first and second sub-wedging member are configured to at least partially slip over each other as they advance towards a centre point in the length of the shaped channel.

This arrangement allows the clamping force on the bracket leg to be gradually increased and applied more uniformly across the body of the bracket leg.

Optionally, the bracket leg comprises a flange arranged to prevent the bracket leg from being entirely extracted from the shaped channel.

Optionally, the flange is further arranged to limit the extent to which the wedging member can be retracted from the shaped channel.

Optionally, the shaped channel has a third channel wall and has a generally right-angle triangular cross-section that corresponds to the cross-section of the wedging member, wherein the bracket comprises an generally L-shaped cross-section corresponding to the shape of the first and second channel walls.

This arrangement allows the wedging member to interface with the shaped channel on one of the three sides (e.g. the hypotenuse) and clamp the bracket leg uniformly against the remaining two sides.

Optionally, the toe-kick plate further comprises a second bracket leg extending from the second surface, receivable by a second said shaped channel in the cabinet body.

Optionally, the bracket leg extends in a direction substantially normal to the plane of the planar main body.

Optionally, the bracket leg comprises one or more relief slots.

These slots serve to reduce the stiffness of the bracket leg such that the clamping forces applied to the bracket can be applied consistently and transferred through the bracket to the first and second channel walls of the shaped channel.

Optionally, the bracket leg has a guiding edge for maintaining alignment of the wedging member relative to the bracket leg as it advances within the shaped channel.

Optionally, the shaped channel comprises a supporting rib that extends into the cabinet body.

Optionally, the shaped channel has a longitudinal axis along which the wedging member is advanceable.

In accordance with a second aspect of the invention, there is provided an appliance comprising: a cabinet body, the cabinet body having a front face extending from an upper part of the appliance towards a floor on which the appliance is positioned, a space provided between the floor and a lower edge of the front face, a shaped channel provided on the cabinet body in the space, and a locking system as claimed in any one of the preceding claims having a toe-kick plate positioned in the space, recessed behind a plane of the front face, with the bracket leg of the locking system received in the shaped channel.

Features from one or more embodiments or configurations may be combined with features of one or more other embodiments or configurations. Additionally, more than one embodiment or configuration may be used together. Also, the following focuses on the use of embodiments of the invention with a refrigeration appliance (i.e., a refrigerator, or freezer, or combination refrigerator/freezer), but embodiments of the invention are equally compatible with incorporation into other appliances, such as other kitchen appliances, for example dishwashers.

As used herein the term “(s)” following a noun means the plural and/or singular form of that noun.

As used herein the term “and/or” means “and” or “or”, or where the context allows both.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This disclosure may also be said broadly to consist in the parts, elements and features referred to or indicated in the specification of the application, individually or collectively, and any or all combinations of any two or more said parts, elements or features.

Where specific integers are mentioned herein which have known equivalents in the art to which this disclosure relates, such known equivalents are deemed to be incorporated herein as if individually set forth.

The disclosure consists in the foregoing and also envisages constructions of which the following gives examples only.

### BRIEF DESCRIPTION OF THE DRAWINGS

Embodiments of the present invention will now be described, by way of example only, with reference to the accompanying drawings, in which:

FIG. 1 is an isometric view of a refrigerator cabinet in accordance with an embodiment of the invention.

FIGS. 2, 3 and 4 show various schematic views of the locking system in accordance with an embodiment of the invention.

FIG. 5 shows a horizontal cross-sectional view from below of the locking system in accordance with an embodiment of the invention.

FIG. 6 shows a view of the locking system in accordance with an embodiment of the invention.

FIGS. 7A and 7B show a perspective view of the locking system in accordance with an embodiment of the invention.

FIG. 7C shows a cross-section of the locking system in accordance with an embodiment of the invention

FIG. 8A shows a cut away view of the locking system in accordance with an embodiment of the invention.

FIG. 8B is a plan view of a cross-section of the locking system in accordance with an embodiment of the invention.

FIG. 9A is a cut away view of the locking system in accordance with an embodiment of the invention while FIG. 9B is a cross-sectional plan view through the locking system of FIG. 9A.

FIG. 10 shows a perspective view of the bracket leg in isolation in accordance with an embodiment of the invention.

### DETAILED DESCRIPTION

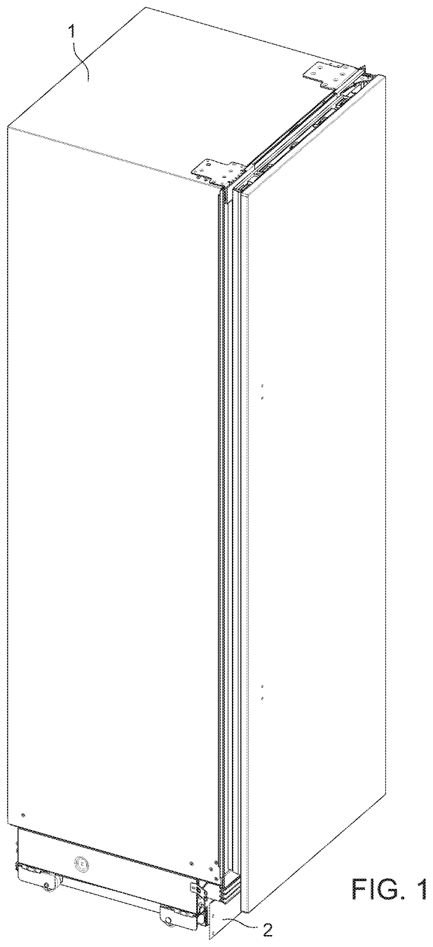

FIG. 1 shows a refrigeration appliance 1 cabinet having a toe-kick plate 2 located beneath the door, forming the lowest portion of the outward facing surface of the refrigerator cabinet, adjacent the floor.

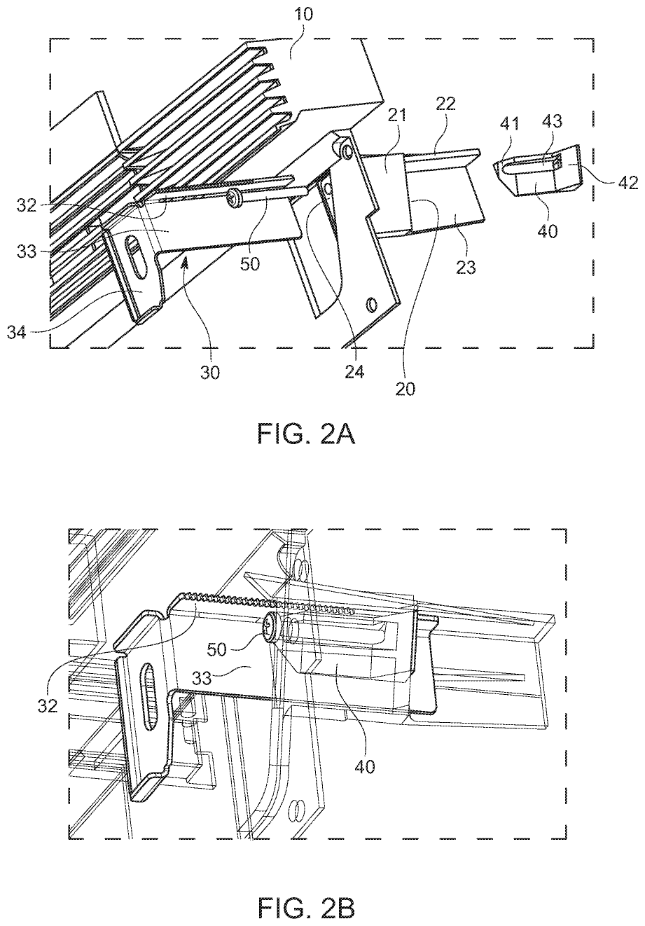

FIGS. 2A and 2B show a close-up of the grille face 10 found at the lower front region of the refrigerator 1. The toe-kick plate 2 (not shown) is attached to the grille face 10 by one or more bracket legs 30 that are configured to engage within a shaped channel 20 in the refrigerator body 1. In the illustrated embodiment, the bracket leg 30 is substantially L-shaped, having a first vertical surface 33 and a second horizontal surface 32, as well as an attachment portion 34 for anchoring the bracket to the toe-kick plate 2. Whilst the vertical 33 and horizontal 32 surfaces are illustrated and described as being at approximately 90 degrees to each other, any suitable arrangement may be employed provided it functions as set out below.

In use, the bracket leg 30 is received by the shaped channel 20 having (see FIG. 2A) a vertical channel wall 23, horizontal channel wall 22 and a connecting angled channel wall 21. In the illustrated embodiment, the vertical 23 and horizontal 22 channel walls extend beyond the angled channel wall 21. In an alternative embodiment, all three walls have the same length. When situated inside the shaped channel 20, the vertical surface 33 of the bracket leg 30 is parallel to the vertical channel wall 23, and the horizontal surface 32 of the bracket leg is parallel to the horizontal channel wall 22.

Also shown is a wedging member 40, having a leading wedge portion 41 and trailing wedge portion 42. In an embodiment, these two wedge portions 41, 42 both have an angle of about 30 degrees (with the face that is adapted to lie flat against vertical wall 23) which, once the wedging member is engaged with the shaped channel, has been found to provide a maximum clamp load whilst being shallow enough to prevent the contact surfaces on the wedging member 40 and the walls of the shaped channel 20 from sticking. In an alternative embodiment, the two wedge portions 41, 42 have different angles. Advantageously, the material of the wedging member 40 can be selected depending on the desired frictional properties. In some embodiments the wedging member 40 is formed of Nylon. Alternatively the wedging member 40 is formed of ABS-though any suitable material may be selected.

The wedging member 40 further includes a channel and through-hole 43 for receiving a threaded rod 50. In an embodiment, the channel and through-hole 43 are provided with a corresponding thread, or threaded insert.

As shown in FIG. 2B, the threaded rod 50 is arranged through the shaped channel 20 and engages the channel and through hole 43 of the wedging member 40. Threaded rod 50 may pass through an opening in a flange 24 (see FIG. 2A) that extends from angled channel wall 21 and partially across the channel toward vertical wall 23, such that by rotating the threaded rod, the wedging member is drawn into the shaped channel 20 from the rear and the angled surfaces of the wedge portions 41, 42 contact corresponding surfaces within shaped channel 20. This contact provides reaction forces in the directions normal to the contacted channel surfaces which are transmitted by the wedging member 40 as horizontal and vertical clamping forces that presses the surfaces of the bracket leg 30 against the corresponding walls of the shaped channel 21. In other words, contact surfaces 21A and 21B have normals with both horizontal and vertical components. This ensures that the surfaces of the bracket leg 30 are always clamped flat to the vertical channel wall 23 and horizontal channel wall 22 of the shaped channel 20, rather than at an angle. Surfaces 21A and 21B may be substantially parallel, particularly when the leading and trailing wedge portions are the same angle. Ideally, the leading and trailing wedge portions, and the contact surfaces 21A and 21B are shaped so that they each contact their respective opposing surface/wedge portion substantially over the entire height of the wedging member 40.

FIGS. 3A and 3B (both of which are from the rear of the appliance) show the wedging portion 40 fully inserted in the shaped channel 20, with the two wedge portions 41, 42 engaging the channel wall 21. Also shown is a dome nut 51 that serves to hold the wedging member 40 in position and prevent it from becoming entirely detached from the locking system. Use of a dome nut 51 further prevents the nut from being run too far onto the threaded rod 50, preventing the user from adjusting the position of the wedging member 40.

FIG. 4 depicts an embodiment in which the inner end of bracket leg 30 is provided with a flange 35 on the leading edge of the vertical surface 33. This flange serves as an end stop to prevent the bracket 30 from being withdrawn entirely from the shaped channel 20 as it will engage with the front face of the grille face 10. It further provides a limit to the extent to which the toe-kick plate can protrude from the refrigerator grille face 10. The flange 35 can also prevent the wedging member 40 from falling out of the shaped channel, in addition or as an alternative to the dome nut 51 shown in FIG. 3.

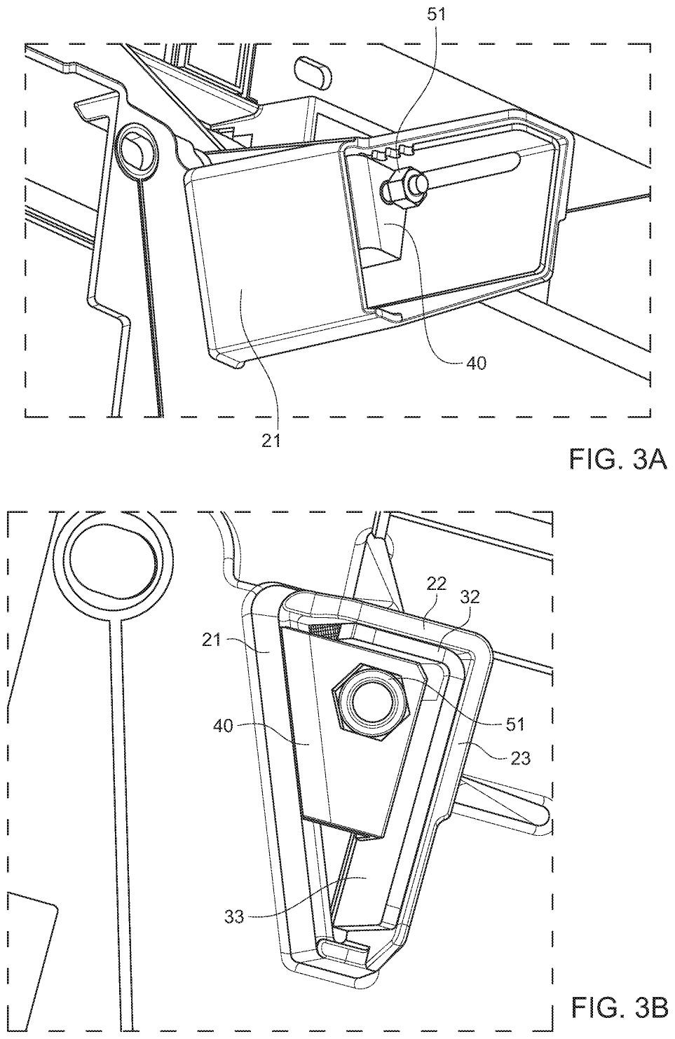

FIG. 5 shows a horizontal cross-section of the locking mechanism from below, wherein the angled channel wall 21 comprises an angled portion 21A to engage the trailing wedge portion 42 of the wedging member 40. In an embodiment, the angled portion 21A has a characteristic angle different to that of the trailing wedge portion 42 so as to minimise the contact area between the trailing wedge portion 42 and the angled portion 21A and prevent sticking.

In use, as the wedging member 40 advances into the shaped channel 20, the trailing wedge portion 42 contacts the angled channel wall 21 of the shaped channel 20 first, via the angled edge portion 21A. In an embodiment, the leading wedge portion 41 subsequently makes contact with a surface of the shaped channel 20, such as the angled channel wall 21. In another embodiment, rather than angled channel wall 21, the leading wedge portion 41 may contact another surface of the shaped channel, such as surface 21B (which may be, for example, a bevelled edge of a boss surrounding the rear side of the through-hole in flange 24) following deformation of the wedging member 40 and/or shaped channel 20 walls as a result of the trailing wedge portion 42 and angled portion 21A moving past each other and deflecting. Ideally, the longitudinal spacing (i.e., along the axis of the channel) between the leading 41 and trailing 42 wedge portions is set to correspond to the longitudinal spacing of surfaces 21A and 21B so that the leading and trailing wedge portions engage with the shaped channel at the same time, although this is not essential.

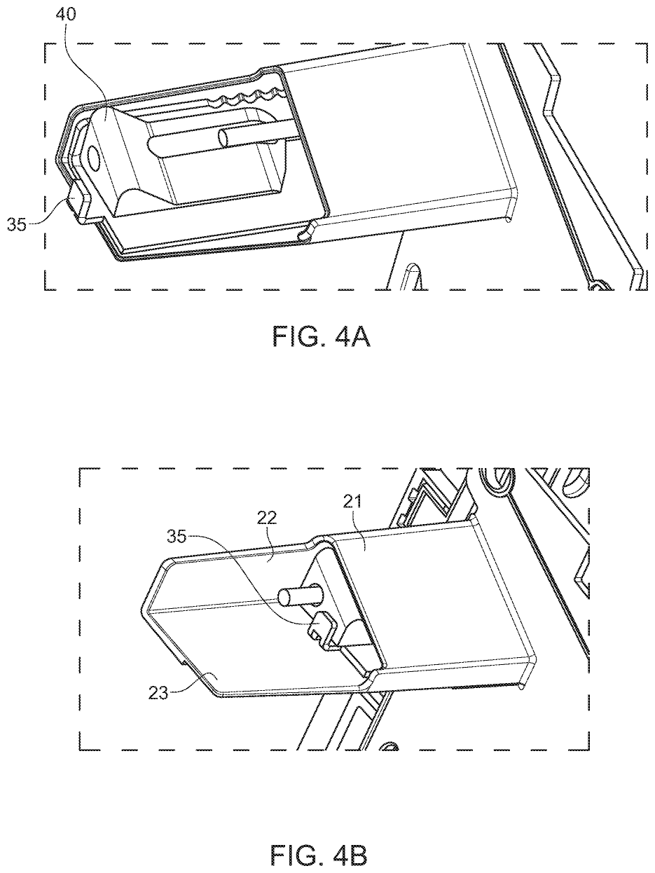

FIG. 6 shows a rear, cross-sectional view of the locking mechanism. Visible in this view are support ribs 24, 25 extending from each of the horizontal 22 and vertical 23 walls, respectively, of the shaped channel into the main body of the refrigerator grille 10. These serve to support and structurally reinforce the shaped channel.

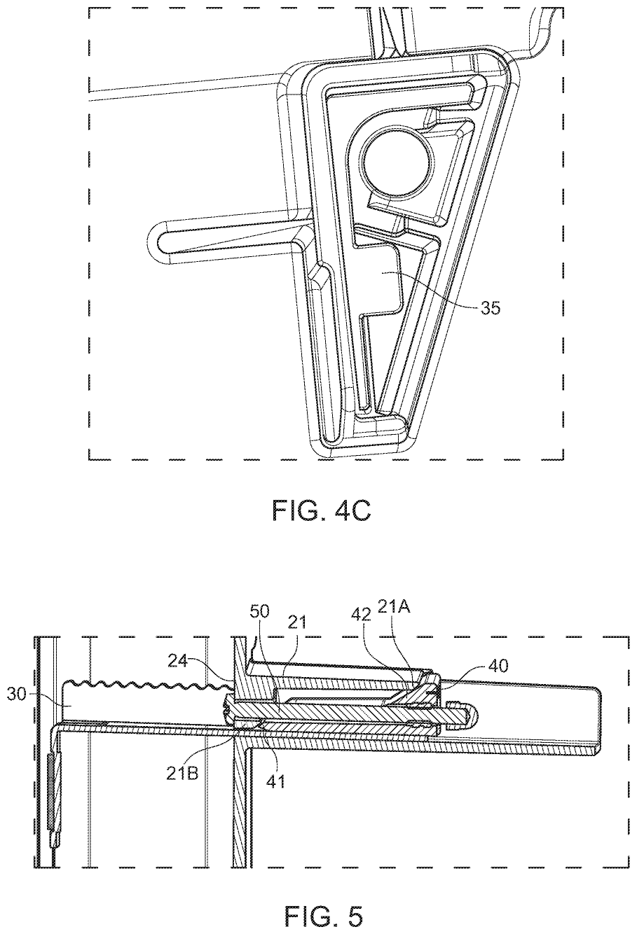

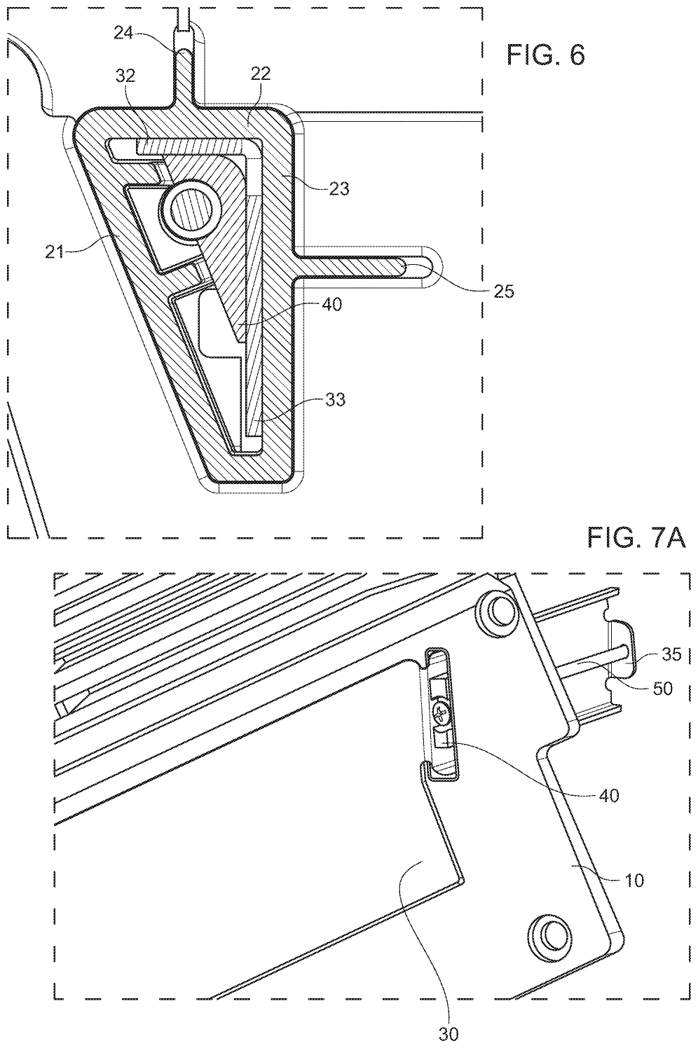

FIGS. 7A and 7B depict an alternative embodiment in which the threaded rod 50 extends through a threaded screw hole in a flange 35 provided at the leading (i.e., rearmost) edge of the bracket leg 30. This embodiment functions in the same manner as that described above, whereby rotating the threaded rod 50 pulls the wedging member 40 forwards through the shaped channel 20 to control the friction force that holds the bracket leg 30 in position. Also visible are lips or hems acting at the edges of the bracket leg surfaces that serve as guiding edges to guide the wedging member 40 and maintain its alignment relative to the bracket leg while it advances along the shaped channel 20.

FIG. 7C shows a cross-section of the locking mechanism used in FIGS. 7A and 7B, which utilises a simple wedge as the wedging member 40.

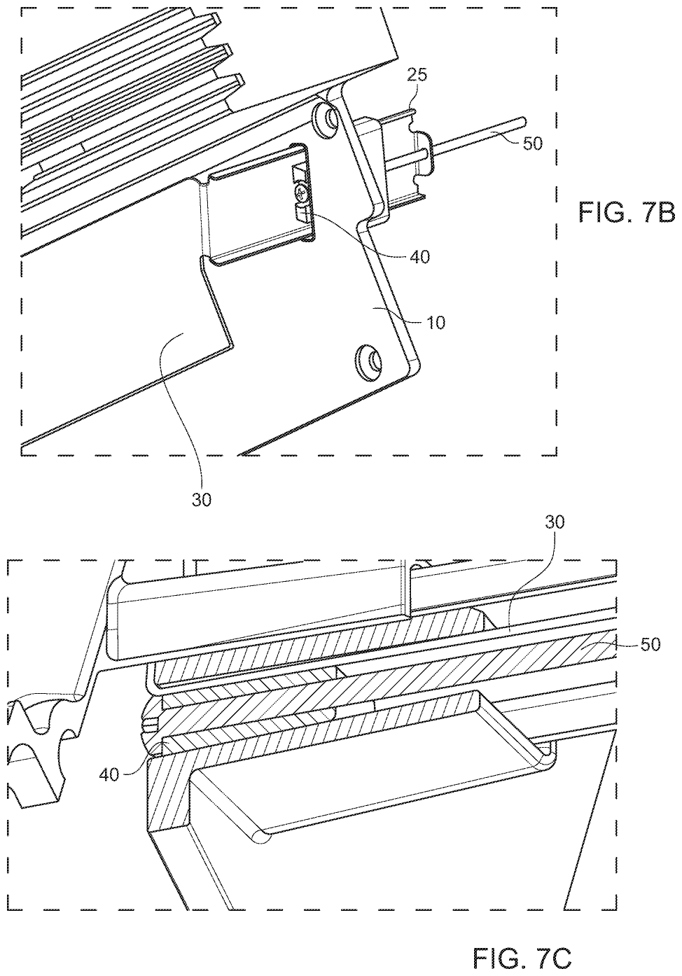

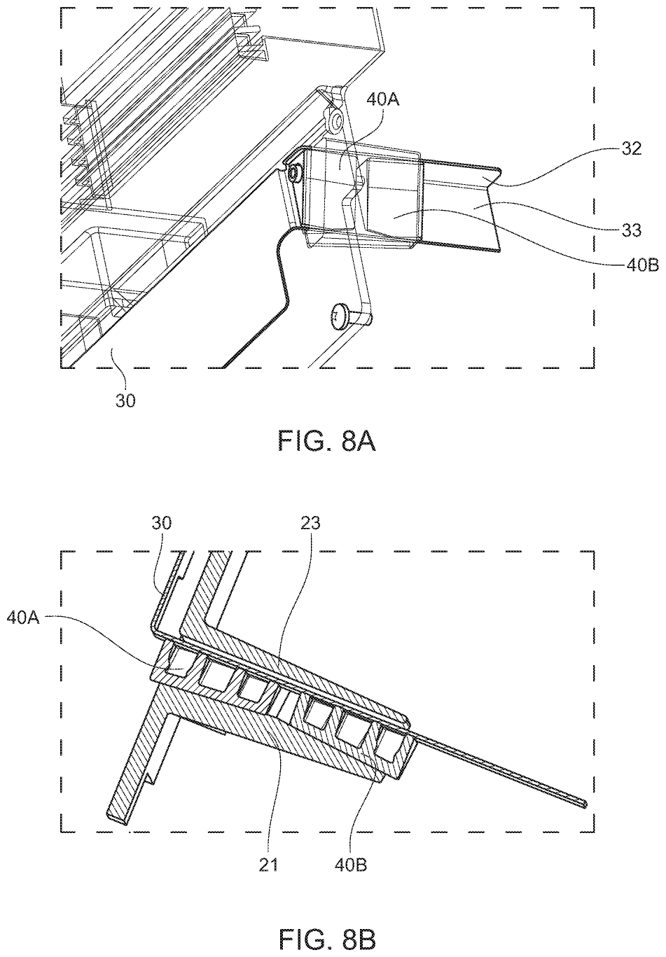

FIG. 8 depicts a further alternative embodiment that utilises a pair of opposing wedging members 40A, 40B. Rotation of the threaded rod 50 acts to pull the two wedging members 40A, 40B towards each other to bias the vertical 33 and horizontal 32 surfaces of the bracket leg 30 against the underlying vertical 23 and horizontal 22 walls of the shaped channel 20. As shown in FIG. 8A, the two wedging members can be provided in the form of a mirrored pair, each configured to engage with the walls of the shaped channel 20 that narrows towards its centre (depicted in FIG. 8B).

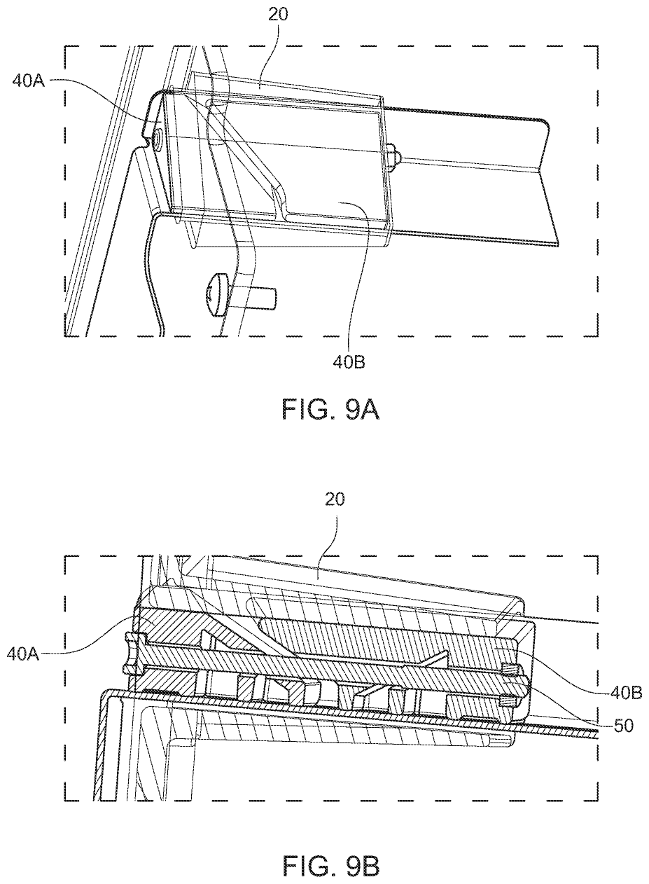

In an alternative embodiment shown in FIGS. 9A and 9B, the wedging members 40A, 40B are provided within a shaped channel 20 having consistently spaced apart, or substantially parallel, channel walls. In this embodiment, the wedging members 40A, 40B are arranged such that they slide over each other when brought together, thereby pushing each other into the channel walls of the shaped channel 20 to lock the bracket leg 30 in position.

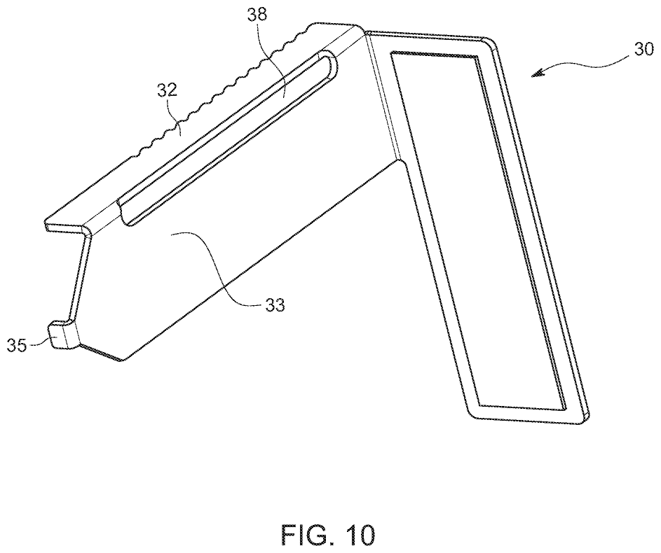

FIG. 10 shows the bracket leg 30, in accordance with an embodiment of the invention, in isolation. Visible on an edge of the horizontal surface 32 is a serrated portion that serves to guide installation of the bracket leg 30 within the shaped channel 20, enabling the user to visually determine the extent or depth to which the bracket leg 30 has been inserted. This is useful when the toe-kick pate 2 has multiple bracket legs 30 that need to be equally inserted in the shaped channels 20 along the length of the grille 10.

Also shown is a relief slot 38 in the form of a cut-out provided along the joining edge of the vertical surface 33 and horizontal surface 32 of the bracket leg 30. This relief slot 38 serves to reduce the stiffness of the bracket leg 30 in the area clamped to the walls of the shaped channel 20 such that the vertical surface 33 and horizontal surface 32 are able to transfer forces to the corresponding vertical wall 23 and horizontal wall 22 of the shaped channel 20 independently. This ensures the clamping force is evenly and consistently distributed along the bracket leg 30 entirely in the directions normal to the vertical surface 33 and horizontal surface 32 such that the exact position of bracket leg 30 within the shaped channel 20 is a function of part tolerances rather than clamping force, where an imbalanced force could operate to ‘squeeze’ the bracket leg 30 outwards from the shaped channel 20.

The foregoing description of the invention includes preferred forms thereof. Modifications may be made thereto without departing from the scope of the invention.

1. A locking system for a toe-kick plate of an appliance, the locking system comprising:
a toe-kick plate having a substantially planar body with a first, inward-facing, surface and a second, outward-facing, surface, the toe-kick plate further comprising a bracket leg extending from the second surface;
a cabinet body having a shaped channel configured to receive at least a portion of the bracket leg, the shaped channel comprising at least first and second channel walls; and
a wedging member locatable between the walls of the shaped channel, such that the bracket leg is frictionally locked within the shaped channel between at least one of the channel walls and the wedging member,
wherein the wedging member is adjustably advanceable within the shaped channel such that a frictional locking force applied to the bracket leg can be varied.

2. The locking system of claim 1, wherein the wedging member comprises a trailing wedge-shaped portion having a first angle at a first position along its length.

3. The locking system of claim 2, wherein the shaped channel has a first engaging surface that is positioned to be engaged by the trailing wedge-shaped portion as the wedging member is advanced within the shaped channel such that the first engaging surface urges the wedging member against the first and/or second channel wall(s).

4. The locking system of claim 2, wherein the wedging member further comprises a leading wedge-shaped portion having a second angle at a second position along its length.

5. The locking system of claim 4, wherein the shaped channel has a second engaging surface that is positioned to be engaged by the leading wedge-shaped portion as the wedging member is advanced within the shaped channel such that the second engaging surface urges the wedging member against the first and/or second channel wall(s).

6. The locking system of claim 4, wherein the first and second angles are the same.

7. The locking system of claim 1, wherein the first and second channel walls are angled towards each other along a first portion of the shaped channel, such that the first portion of the shaped channel has a non-uniform width along its length.

8. The locking system of claim 7, wherein in a second portion of the shaped channel, the first and second channel walls are angled away from each other.

9. The locking system of claim 1, wherein the shaped channel comprises a wedged portion having a third angle configured to engage the wedging member.

10. The locking system of claim 9, wherein the angle of the wedged portion is different to that of the wedging member.

11. The locking system of claim 1, further comprising a threaded rod arranged to extend at least partially along the length of the shaped channel and through the wedging member, the threaded rod restrained from moving axially relative to the cabinet body such that rotating the threaded rod adjusts the position of the wedging member along the shaped channel.

12. The locking system of claim 11, wherein the threaded rod further comprises a nut or abutment at or near its end to limit the extent of travel of the wedging member along the threaded rod.

13. The locking system of claim 11, wherein the threaded rod is attached at one end to the bracket leg.

14. The locking system of claim 1, wherein the threaded rod engages with a threaded through-hole in the bracket leg.

15. The locking system of claim 1, wherein the wedging member comprises first and second sub-wedging members, and wherein each of the first and second sub-wedging members are independently advanceable along the shaped channel.

16. The locking system of claim 15, wherein the first sub-wedging member is locatable in a first portion along the shaped channel and the second sub-wedging member is locatable in a second portion along the shaped channel.

17. The locking system of claim 15, wherein the first and second sub-wedging members are configured to at least partially slip over each other as they advance towards a centre point along the shaped channel.

18. The locking system of claim 1, wherein the shaped channel has a third channel wall and has a generally right-angle triangular cross-section that corresponds to the cross-section of the wedging member, wherein the bracket leg comprises a generally L-shaped cross-section corresponding to the shape of the first and second channel walls.

19. (canceled)

20 (canceled)

21. (canceled)

22. The locking system of claim 1, wherein the bracket leg has a guiding edge for maintaining alignment of the wedging member relative to the bracket leg as it advances within the shaped channel.

23. (canceled)

24. (canceled)

25. An appliance comprising:
a cabinet body, the cabinet body having a front face extending from an upper part of the appliance towards a floor on which the appliance is positioned, a space provided between the floor and a lower edge of the front face, a shaped channel provided on the cabinet body in the space,
a toe-kick plate positioned in the space, recessed behind a plane of the front face, and
a locking system for the toe-kick plate, the locking system comprising:
the toe-kick plate having a substantially planar body with a first, inward-facing, surface and a second, outward-facing, surface, the toe-kick plate further comprising a bracket leg extending from the second surface;
a cabinet body having a shaped channel configured to receive at least a portion of the bracket leg, the shaped channel comprising at least first and second channel walls; and
a wedging member locatable between the walls of the shaped channel, such that the bracket leg is frictionally locked within the shaped channel between at least one of the channel walls and the wedding member;
wherein the wedging member is adjustably advanceable within the shaped channel such that a frictional locking force applied to the bracket leg can be varied, wherein the bracket leg of the locking system is received in the shaped channel.
